(19) United States
(12) Patent Application Publication
(10) Pub. No.: US 2007/0276855 A1
(43) Pub. Date: Nov. 29, 2007

(54) METHODS, APPARATUSES, SYSTEMS, AND COMPUTER PROGRAM PRODUCTS FOR GENERATING A FILE STRUCTURE TO ACCESS MULTIMEDIA FILES

(75) Inventor: Wei-Hung Huang, Hsin-chu City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: MediaTek, Inc., Hsin-Chu City (TW)

(21) Appl. No.: 11/382,386

(22) Filed: May 9, 2006

(51) Int. Cl. G06F 17/00

(52) U.S. Cl. 707/102

(57) ABSTRACT

Methods, apparatuses, systems, and computer program products for generating a file structure to access multimedia files are provided. The system, connected to a first memory, comprises a second memory and a processing unit. The first memory stores the multimedia files. The processing unit generates real directories in the second memory according to metadata of the multimedia files; copies one of the multimedia files to one corresponding real directory; and generates one link under one of the real directories according to the metadata, wherein the corresponding real directory is one of the real directories.

### CROSS-REFERENCES TO RELATED APPLICATIONS

Not applicable.

### BACKGROUND OF THE INVENTION

1. Field of the Invention

The present invention relates to methods, apparatuses, systems, and computer program products for generating a file structure to access multimedia files; in particular, relates to methods, apparatuses, systems, and computer program products for generating a file structure to access multimedia files by generating real directories and links to multimedia files.

2. Descriptions of the Related Art

Due to the rapid development of multimedia technologies, people like to use multimedia files in their daily life. Companies also prefer to use multimedia files to introduce their organizations or products as well. The tendency leads to huge amount of usage of multimedia files.

Metadata of multimedia files provide summary-like information of the multimedia files, including a title, a date, an author, and an attribute, etc. These multimedia files are mostly stored in internal storages, such as hard discs, or removable storages, such as CDs, DVDs, USB storages, flash cards, and the like. Generally speaking, the storage of the multimedia files is created in only one data arrangement. For example, MP3 files sorted by singers which are unable to be searched by attributes. In other words, the current storage solutions fail to provide various file structures to sort multimedia files in different ways in order to facilitate accessing a desired file. Consequently, how to generate a file structure to facilitate access of multimedia files is a serious issue in the industrial field.

### SUMMARY OF THE INVENTION

An object of this invention is to provide a method for generating a file structure to access multimedia files. The method comprises the steps of generating real directories according to metadata of the multimedia files; copying one of the multimedia files to one corresponding real directory, wherein the corresponding real directory is one of the real directories; and generating one link under one of the real directories according to the metadata.

Another object of this invention is to provide a method for generating a file structure to access multimedia files. The method comprises the steps of generating real directories according to metadata of the multimedia files and generating one link under one of the real directories according to the metadata.

Another object of this invention is to provide a computer program product for storing a computer program to execute a method for generating a file structure to access multimedia files. The computer program comprises code for generating real directories according to metadata of the multimedia files; code for copying one of the multimedia files to one corresponding real directory, wherein the corresponding real directory is one of the real directories; and code for generating one link under one of the real directories according to the metadata.

Another object of this invention is to provide a computer program product for storing a computer program to execute a method for generating a file structure to access multimedia files. The computer program comprises code for generating real directories according to metadata of the multimedia files and code for generating one link under one of the real directories according to the metadata.

A further object of this invention is to provide an apparatus for generating a file structure to access multimedia files. The apparatus comprises a first generator, a copying unit and a second generator. The first generator is configured to generate real directories according to metadata of the multimedia files. The copying unit is configured to copy one of the multimedia files to one corresponding real directory, wherein the corresponding real directory is one of the real directories. The second generator is configured to generate one link under one of the real directories according to the metadata.

A further object of this invention is to provide an apparatus for generating a file structure to access multimedia files. The apparatus comprises a first generator and a second generator. The first generator is configured to generate real directories according to metadata of the multimedia files. The second generator is configured to generate one link under one of the real directories according to the metadata.

A further object of this invention is to provide a system for generating a file structure to access multimedia files. The multimedia files are stored in a first memory. The system comprises a second memory and a processing unit. The processing unit is configured to generate real directories according to metadata of the multimedia files in the second memory, copy one of the multimedia files to one corresponding real directory, and generate one link under one of the real directories according to the metadata, wherein the corresponding real directory is one of the real directories.

A further object of this invention is to provide a system for generating a file structure to access multimedia files. The system comprises a memory and a processing unit. The memory is configured to store the multimedia files. The processing unit is configured to generate real directories according to metadata of the multimedia files and generate one link under one of the real directories according to the metadata.

Yet a further object of this invention is to provide an apparatus for generating a file structure to access multimedia files. The apparatus comprises means for generating real directories according to metadata of the multimedia files; means for copying one of the multimedia files to one corresponding real directory, wherein the corresponding real directory is one of the real directories; and means for generating one link under one of the real directories according to the metadata.

Yet a further object of this invention is to provide an apparatus for generating a file structure to access multimedia files. The apparatus comprises means for generating real directories according to metadata of the multimedia files and means for generating one link under one of the real directories according to the metadata.

The present invention is capable of generating a file structure according to metadata of multimedia files so that the multimedia files can be sorted in several ways.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a first embodiment of this invention;

FIG. 2 illustrates an example of a file structure;

FIG. 3 illustrates file structures generated by the first embodiment;

FIG. 4 illustrates a flowchart of a second embodiment of this invention;

FIG. 5 illustrates a fourth embodiment of this invention; and

FIG. 6 illustrates a flowchart of a sixth embodiment of this invention.

### DESCRIPTION OF THE PREFERRED EMBODIMENT

The invention provides methods, apparatus, systems, and computer program products to generate a file structure to access multimedia files. Each of the multimedia files may be an audio, an image, a texture, or a video file. The file structure comprises real directories, links to real directories, and/or links to multimedia files.

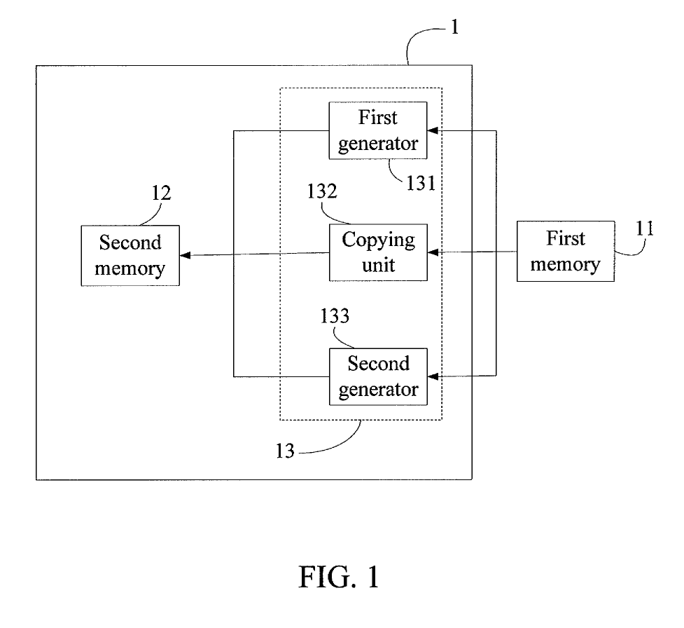

FIG. 1 illustrates a first embodiment of this invention, which is a system 1 for generating a file structure to access multimedia files. The system 1 is, for example, a computer and connected to a first memory 11, e.g. a removable disc, which stores the multimedia files. The system 1 comprises a second memory 12 and a processing unit 13. The second memory 12 is, for example, a hard disc. The processing unit 13, a CPU, first retrieves metadata of the multimedia files and then generates real directories according to the metadata of the multimedia files in the second memory 12. After the real directories are generated, the processing unit 13 copies at least one of the multimedia files to one corresponding real directory, and generates at least one link under one of the real directories according to the metadata.

More specifically, the processing unit 13 comprises a first generator 131, a copying unit 132, and a second generator 133. The first generator 131 analyzes the metadata and then generates the real directories in the second memory 12. The copying unit 132 copies at least one of the multimedia files from the first memory 11 to at least one corresponding real directory which is generated in the second memory 12 by the first generator 131. The second generator 133 generates at least one link under of the real directories according to the metadata. That is, the second memory 12 stores various file structures for users to access the multimedia files in more than one way.

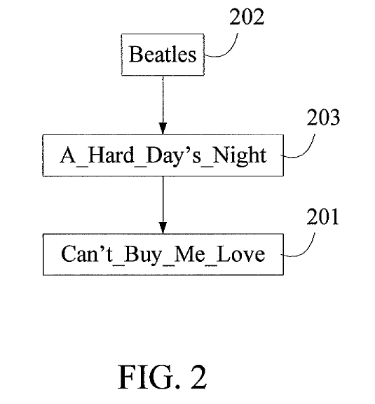

The following is a practical example to specify how the system 1 operates. Initially, the first memory 11 stores an MP3 file 201 named “Can't_Buy_Me_Love” under a root directory “Beatles” 202 and a subdirectory “A_Hard_Day's_Night” 203 as FIG. 2 shows. Metadata of the MP3 file 201 comprises a date, or an artist, an album, and a title thereof, wherein the date column records the achievement date (2006/04/06) of the MP3 file 201, the artist column records “Beatles,” the album column records “A_Hard_Day's_Night,” and the title column records “Can't_Buy Me_Love.” It is apparent that the file structure for storing the MP3 file 201 is arranged first in artists and then in albums. That is, users have to know the artist and the album of the MP3 file 201 to find it quickly. Since the metadata comprises many pieces of information related to the MP3 file 201, the system 1 is capable of sorting the MP3 file 201 in several ways by retrieving the information.

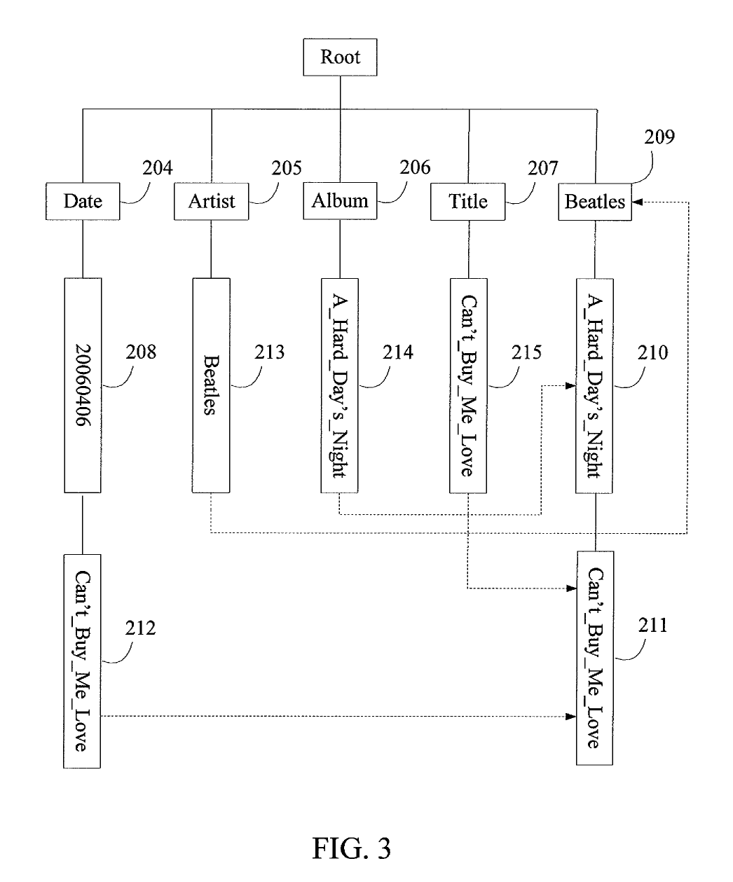

As FIG. 3 shows, the first generator 131 first generates real directories comprising a date directory 204, an artist directory 205, an album directory 206, and a title directory 207 in a root directory of the second memory 12 according to the columns of the metadata, and also generates a “20060406” directory 208 under the date directory 204 according to the date column of the metadata.

The copying unit 132 copies the MP3 file 201 as well as its file structure from the first memory 11 to the root memory of the second memory 12, i.e., creates a duplicate of the MP3 file 201 and the file structure in the second memory 12. More particularly, the copying unit 132 creates a duplicated directory 209 of the directory 202, a duplicated directory 210 of the directory 203, and a duplicated file 211 of the MP3 file 201. Then the second generator 133 generates four links 212-215 according to the metadata. The link 212, named as “Can't_Buy_Me_Love,” link to the duplicated file 211 and is stored in the “20060406” directory 208. The link 213, named as “Beatles,” links to the duplicated directory 209 and is stored in the artist directory 205. The link 214, named as “A_Hard_Day's_Night,” links to the duplicated directory 210 and is stored in the album directory 206. The link 215, named as “Can't_Buy_Me_Love,” links to the duplicated file 211 and is stored in the title directory 207.

Based on the file structures in the second memory 12, the system 1 is capable of providing various access ways to the MP3 file 211. For example, a user may access the MP3 file 211 by its artist, album, title or even achievement date.

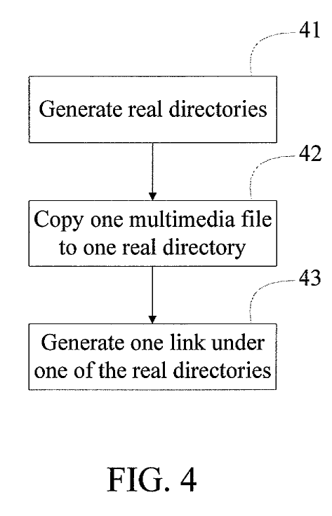

A second embodiment of this invention is illustrated in FIG. 4, which is a method for generating a file structure to access multimedia files. The second embodiment may be performed by a system like the first embodiment. The second embodiment first executes step 41 to generate real directories according to metadata of the multimedia files. Then, the second embodiment executes step 42 to copy one of the multimedia files to one corresponding real directory, wherein the corresponding real directory is one of the real directories. Finally, the second embodiment executes step 43 to generate one link under one of the real directories according to the metadata. In addition to the steps shown in FIG. 4, the second embodiment may perform all of the operations or functions recited in the first embodiment.

A third embodiment of this invention is a computer program product for storing a computer program to execute a method for generating a file structure to access multimedia files. The method is similar to the second embodiment. The computer program at least comprises code for generating real directories according to metadata of the multimedia files; code for copying one of the multimedia files to one corresponding real directory, wherein the corresponding real directory is one of the real directories; and code for generating one link under one of the real directories according to the metadata. In addition, the third embodiment may perform all of the operations or functions of the second embodiment. The third embodiment can be a floppy disc, a hard disc, an optical disc, a flash disc, a tape, an internet accessible database or any storage medium with a similar functionality of storage which is easily thought by people skilled in the field.

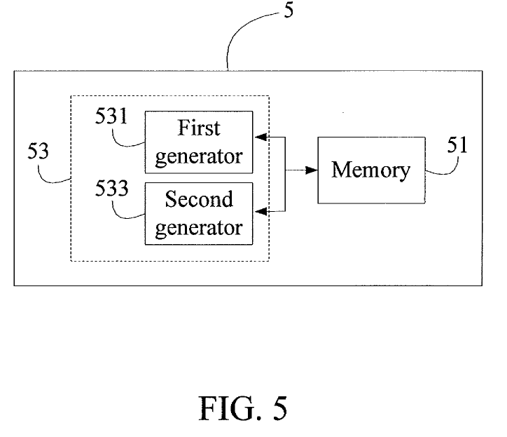

FIG. 5 illustrates a fourth embodiment of this invention, which is a system 5 for generating a file structure to access multimedia files. The system 5, a computer, comprises a memory 51 and a processing unit 53. The memory 51 is, for example, a hard disc for storing the multimedia files. The processing unit 53, a CPU, first retrieves metadata of the multimedia files and then generates real directories according to the metadata of the multimedia files in the memory 51. After the real directories are generated, the processing unit 53 generates at least one link under one of the real directories according to the metadata. In contrast with the system 1 of the first embodiment the system 5 does not copy the multimedia files from an external memory such as the first memory 11. For other operations or functions, the fourth embodiment may perform just like the first embodiment.

More specifically, the processing unit 53 comprises a first generator 531 and a second generator 533. The first generator 531 is configured to generate the real directories according to the metadata of the multimedia files. The second generator 533 is configured to generate at least one link under of the real directories according to the metadata.

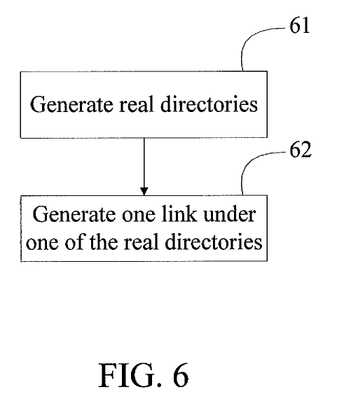

A fifth embodiment of this invention is illustrated in FIG. 6, which is a method for generating a file structure to access multimedia files. The fifth embodiment may be performed by a system like the fourth embodiment. The fifth embodiment first executes step 61 to generate real directories according to metadata of the multimedia files. Then, the fifth embodiment executes step 62 to generate one link under one of the real directories according to the metadata. In addition to the steps shown in FIG. 6, the fifth embodiment may perform all of the operations or functions recited in the fourth embodiment.

A sixth embodiment of this invention is a computer program product for storing a computer program to execute a method for generating a file structure to access multimedia files. The method is similar to the fifth embodiment. The computer program at least comprises code for generating real directories according to metadata of the multimedia files and code for generating one link under one of the real directories according to the metadata. In addition, the sixth embodiment may perform all of the operations or functions recited in the fifth embodiment. The computer program product can be a floppy disc, a hard disc, an optical disc, a flash disc, a tape, an internet accessible database or any storage medium with a similar functionality of storage which is easily thought by people skilled in the field.

Accordingly, the present invention is capable of generating one or more file structures to facilitate access of multimedia files.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for generating a file structure to access multimedia files, the method comprising the steps of:
generating real directories according to metadata of the multimedia files;
copying one of the multimedia files to one corresponding real directory, wherein the corresponding real directory is one of the real directories; and
generating one link under one of the real directories according to the metadata.

2. The method of claim 1, wherein the link links to one of the multimedia files.

3. The method of claim 1, wherein the link links to one of the real directories.

4. The method of claim 1, wherein each of the multimedia files is one of an audio, an image, a texture, and a video file.

5. The method of claim 1, wherein the step of generating one link responds to at least one of a date, an artist, an album, and a title of the multimedia files, and a combination thereof.

6. A method for generating a file structure to access multimedia files, the method comprising the steps of:
generating real directories according to metadata of the multimedia files; and
generating one link under one of the real directories according to the metadata.

7. The method of claim 6, wherein the link links to one of the multimedia files.

8. The method of claim 6, wherein the link links to one of the real directories.

9. The method of claim 6, wherein each of the multimedia files is one of an audio, an image, a texture, and a video file.

10. The method of claim 6, wherein the step of generating one link responds to at least one of a date, an artist, an album, and a title of the multimedia files, and a combination thereof.

11. A computer program product for storing a computer program to execute a method for generating a file structure to access multimedia files, the computer program comprising:
code for generating real directories according to metadata of the multimedia files;
code for copying one of the multimedia files to one corresponding real directory, wherein the corresponding real directory is one of the real directories; and
code for generating one link under one of the real directories according to the metadata.

12. The computer program product of claim 11, wherein the link links to one of the multimedia files.

13. The computer program product of claim 11, wherein the link links to one of the real directories.

14. The computer program product of claim 11, wherein each of the multimedia files is one of an audio, an image, a texture, and a video file.

15. The computer program product of claim 11, wherein code for generating one link responds to at least one of a date, an artist, an album, and a title of the multimedia files, and a combination thereof.

16. A computer program product for storing a computer program to execute a method for generating a file structure to access multimedia files, the computer program comprising:
code for generating real directories according to metadata of the multimedia files; and
code for generating one link under one of the real directories according to the metadata.

17. The computer program product of claim 16, wherein the link links to one of the multimedia files.

18. The computer program product of claim 16, wherein the link links to one of the real directories.

19. The computer program product of claim 16, wherein each of the multimedia files is one of an audio, an image, a texture, and a video file.

20. The computer program product of claim 16, wherein the code for generating one link responds to at least one of a date, an artist, an album, and a title of the multimedia files, and a combination thereof.

21. An apparatus for generating a file structure to access multimedia files, the apparatus comprising:
a first generator for generating real directories according to metadata of the multimedia files;
a copying unit for copying one of the multimedia files to one corresponding real directory, wherein the corresponding real directory is one of the real directories; and
a second generator for generating one link under one of the real directories according to the metadata.

22. The apparatus of claim 21, wherein the link links to one of the multimedia files.

23. The apparatus of claim 21, wherein the link links to one of the real directories.

24. The apparatus of claim 21, wherein each of the multimedia files is one of an audio, an image, a texture, and a video file.

25. The apparatus of claim 21, wherein the second generator generates the link in response to at least one of a date, an artist, an album, and a title of the multimedia files, and a combination thereof.

26. An apparatus for generating a file structure to access multimedia files, the apparatus comprising:
a first generator for generating real directories according to metadata of the multimedia files; and
a second generator for generating one link under one of the real directories according to the metadata.

27. The apparatus of claim 26, wherein the link links to one of the multimedia files.

28. The apparatus of claim 26, wherein the link links to one of the real directories.

29. The apparatus of claim 26, wherein each of the multimedia files is one of an audio, an image, a texture, and a video file.

30. The apparatus of claim 26, wherein the second generator generates the link in response to at least one of a date, an artist, an album, and a title of the multimedia files, and a combination thereof.

31. A system for generating a file structure to access multimedia files, the multimedia files being stored in a first memory, the system comprising:
a second memory; and
a processing unit for generating real directories according to metadata of the multimedia files in the second memory, copying one of the multimedia files to one corresponding real directory, and generating one link under one of the real directories according to the metadata;
wherein the corresponding real directory is one of the real directories.

32. A system for generating a file structure to access multimedia files, the system comprising:
a memory for storing the multimedia files;
a processing unit for generating real directories according to metadata of the multimedia files and generating one link under one of the real directories according to the metadata.

33. An apparatus for generating a file structure to access multimedia files, the apparatus comprising:
means for generating real directories according to metadata of the multimedia files;
means for copying one of the multimedia files to one corresponding real directory, wherein the corresponding real directory is one of the real directories; and
means for generating one link under one of the real directories according to the metadata.

34. An apparatus for generating a file structure to access multimedia files, the apparatus comprising:
means for generating real directories according to metadata of the multimedia files; and
means for generating one link under one of the real directories according to the metadata.
